(19) United States
(12) Patent Application Publication
(10) Pub. No.: US 2023/0090345 A1
(43) Pub. Date: Mar. 23, 2023

(54) APPARATUS AND METHOD FOR MIXING ELASTOMERIC MATERIALS

(71) Applicant: POMINI RUBBER & PLASTICS S.R.L., RESCALDINA (IT)

(72) Inventor: ROBERTO REGALIA, RESCALDINA (IT)

(21) Appl. No.: 17/795,602

(22) PCT Filed: Feb. 18, 2021
(86) PCT No.: PCT/IB2021/051372

§ 371 Date: Jul. 27, 2022

(30) Foreign Application Priority Data
Feb. 20, 2020 (IT) 102020000003461

(51) Int. Cl. B29B 7/48; B29B 7/60; B29B 7/72; B29B 7/74; B29B 7/90; B29C 48/40; B29C 48/41; B29C 48/525

(52) U.S. Cl. CPC B29B 7/484; B29B 7/488; B29B 7/60; B29B 7/726; B29B 7/7495; B29B 7/90; B29C 48/402; B29C 48/41; B29C 48/525

(57) ABSTRACT

A machine for mixing elastomeric materials with a drive and mixing unit where the mixing chamber is arranged downstream of the drive unit; and a discharge chamber is arranged downstream of the mixing chamber. They communicate towards upstream, and are provided with a discharge opening for discharging the mixture. They include a signal indicating the presence or absence of a mixture. The machine can cause during a mixing step, at least one reversal by the drive unit of a sense of rotation of the rotors and therefore of a sense of advancing movement in the axial direction of the mixture from/towards the mixing chamber and towards/from the discharge chamber, to keep mixing of the mixture active only inside the mixing chamber.

The present invention relates to a machine for mixing elastomeric materials with a mixing chamber operating at ambient pressure.

It is known in the technical sector relating to the production of rubber and/or plastic-based compounds that there exists the need to perform the mixing of elastomeric materials by means of which, using a suitable process, several raw materials (ingredients) which are heterogeneous (for example, rubbers, mineral fillers, resins, various additives) and different and separate from each other are converted into a homogeneous product—the so-called “compound”—which incorporates all the base components introduced at the start of the process.

It is also known that the actions which generally occur during the mixing process may be summarized as follows:

Incorporation of the ingredients in the polymer matrix;
Dispersion, i.e. the transformation from agglomerates of particles into aggregates; this basically consists in the reduction of the size of the fillers (for example carbon black) introduced into the polymer matrix;
Distribution/homogenization of all the primary materials.

It is also known that all these actions depend on the movement range (speed and pressure) imparted to the materials being processed by the movement of the moving surfaces (cylinders, screws, rotors) of the mixing machines. In particular, it is known that, while the dispersion depends on the characteristics of the movement range, such as the cutting force and deformation gradient, the distribution of the various ingredients in the polymer matrix depends on the efficiency of the speed range, i.e. the possibility of moving the mixture without creating stagnation points or zones of the mixture where there are pressure peaks.

One of the main problems to be dealt with during the process of mixing highly viscous materials, however, consists in the need to control the temperature of the mixture, which must be kept within certain limits to prevent the triggering of undesirable degradation or pre-crosslinking reactions.

Higher temperatures arise more significantly in those technologies which involve mixing in so-called closed chambers, since processing takes place at pressures which in turn are relatively high.

The undesirable increase in temperature during mixing also occurs during the mixing performed by means of machines of the type which are generally known as “dump extruders”, namely so-called conical, inter-penetrating, counter-rotating twin-screw extruders, in which the discharge/outlet zone of the machine for discharge/outlet of the mixture must be:
closed during a first mixing step in order to allow recirculation of the ingredients and the mixture being formed, which is made to advance against a closing door for closing a discharge opening; and
then opened in the axial direction by means of said door, in order to allow discharging of the mixture.

Examples of such machines are for example known from US 2007/0159916. Mixing inside closed chambers, however, results in the uncontrolled and undesirable increase in the temperature of the mixture with the consequent drawbacks mentioned above.

A further example of closed-chamber mixing is known from WO2017-093849, which describes a process for the production of an elastomeric compound comprising:
feeding into a batch mixer, comprising a pair of rotors housed inside a mixing chamber and a piston arranged above the rotors, together with an elastomeric polymer, at least 10 phr of silica reinforcing filler and at least one silane coupling agent;
mixing inside the batch mixer the elastomeric polymer, the silica reinforcing filler and the silane coupling agent so as to obtain a batch of an intermediate mixture;
feeding the batch of intermediate mixture from the batch mixer to a twin-screw conical mixer having a mixing chamber provided with an inlet mouth and an outlet mouth, with a first chamber part close to the outlet mouth (discharge chamber) and arranged downstream of a second chamber part, provided with said inlet mouth, two counter-rotating conical screws converging towards the outlet mouth, and a door designed to assume a configuration for closing and opening the outlet mouth;
mixing the intermediate mixture inside the twin-screw conical mixer with the door closed while controlling the temperature which is kept between 135 and 145° C. in order to obtain the elastomeric compound (108);
discharging the elastomeric compound from the open outlet mouth.

In the process according to WO2017-093849, mixing is performed almost entirely inside the part of the twin-screw mixer chamber close to the closed outlet mouth, with the conical screws which rotate in a first sense of rotation so as to push the mixture against the door which closes the outlet mouth.

The pressure inside the twin-screw conical mixer is greater than the ambient pressure since the mixer is connected sealingly with the outlet of the batch mixer inside which the pressure is high owing to the action of the piston, the outlet mouth is closed and the temperature must be kept high (135-145° C.) so that at least 50% of the quantity of silane coupling agent reacts with the reinforcing filler inside the twin-screw conical mixer.

In order to improve mixing, the document propose inverting for brief periods the direction of rotation of the conical screws, without however the mixture leaving the mixing chamber part proximal to the closed outlet mouth.

In WO2017-093849, in order to keep the temperature within the desired range, the temperature is measured inside the chamber and, based on the measurement, a speed of rotation of the conical screws is adjusted in the direction of advancing movement of the mixture towards the outlet mouth and against the closing door thereof.

The technical problem which is posed, therefore, is that of providing mixing machines of the type known generally as “dump extruders” which allow mixing of elastomeric materials without alteration of their properties or only limited alteration thereof, allowing in particular the temperature of the mixture to be kept under control, preventing an undesirable increase thereof during mixing.

In connection with this problem, it is also required that this machine should have small dimensions, be easy and inexpensive to produce and assemble and be able to be easily installed also in any user location.

These results are obtained according to the present invention by a machine for the mixing of elastomer-based materials according to the herein disclosed subject matter.

Therefore, a machine for mixing elastomeric materials according to the invention comprises a mixing unit and a drive unit, the mixing unit comprising:
a mixing chamber arranged downstream of the drive unit;
a discharge chamber arranged downstream of the mixing chamber with which it communicates towards upstream, and provided with an opening for discharging the mixture;
a pair of inter-penetrating and counter-rotating conical rotors which are respectively connected upstream with the drive unit and have their vertices situated at the discharge mouth of the discharge chamber; each rotor comprises a respective feeder screw mirror-inverted with respect to the other one.

The machine according to the present invention is characterized in that the mixing chamber has at least one opening towards the outside adapted to keep it connected with the external environment so as to ensure that its internal pressure remains at substantially atmospheric values and in that it comprises detection means arranged and configured to detect the presence of mixture inside the discharge chamber and to emit at least one signal for indicating the presence or absence of the mixture inside the discharge chamber; based on the signal indicating the presence or absence of mixture, the machine is configured to perform, during a mixing step, at least one reversal by the drive unit of the sense of rotation of the rotors and therefore the sense of advancing movement of the mixture in the axial direction from/towards the mixing chamber and towards/from the discharge chamber, so as to keep mixing active only inside the mixing chamber, the internal pressure of which is at substantially atmospheric values.

With this configuration, the ingredients being mixed are kept substantially always inside the mixing chamber which, being open towards the outside and therefore at a substantially atmospheric pressure, does not cause undesirable increases in the pressure and/or the temperature of the mixture, avoiding damaging effects on the mixture such as alteration of the chemico-physical characteristics of the fillers and/or pre-crosslinking of the said mixture; an optimum degree of mixing is furthermore obtained. With the machine according to the present invention it is therefore possible to obtain in a simple manner a high quality of the mixture.

Furthermore, advantageously, the machine does not require doors for closing the discharge mouth and against which pushing the mixture, so that the discharge mouth may be kept open during mixing, making it easier to maintain the ambient pressure inside the mixing chamber and therefore the quality of the mixture, resulting at the same time in simplification of the structure and configuration of the machine.

Preferably, the detection means are arranged inside the discharge chamber in the proximity of the zone for connection to the mixing chamber.

The mixing chamber and the discharge chamber are preferably frustoconical and axially connected together.

According to a preferred embodiment, a loading opening for loading the ingredients to be mixed is provided, said opening being preferably one of said at least one connection opening for connecting the mixing chamber to the outside environment.

The drive unit may comprise at least one motor with a shaft for moving one of the two rotors and a transmission designed to reverse the sense of rotation of the drive shaft and connected to the other one of the two rotors.

The machine preferably comprises control means for controlling and actuating the moving parts of the machine, designed to perform automatic operation thereof; said control means may in particular be configured to send automatically to the drive unit a command for reversing the sense of rotation of the rotors in response to a signal indicating the presence or absence of mixture inside the discharge chamber, emitted by the detection means during the mixing step. Said reversal command is preferably sent immediately after the emission of a signal indicating the presence (or eventually the absence) of mixture inside the discharge chamber and/or after a predefined time interval Δt following the emission of a signal indicating the absence (or eventually the presence) of mixture inside the discharge chamber.

The control means may also be configured to switch an operating mode of the machine from a mixing mode to a discharge mode, where a sense of rotation of the rotors is maintained so as to cause the movement of the mixture from the mixing chamber towards the discharge chamber and the axial discharging thereof through the discharge mouth.

Preferably, a cover is movable into a closed or open position so as to close the mixing chamber during the axial discharging of the mixture.

The present disclosure relates furthermore to a mixing process for mixing elastomeric materials by means of a machine comprising the steps of:
feeding to the mixing chamber ingredients to be mixed to obtain a mixture;
mixing of the ingredients by the feeder screws of the rotors which are made to rotate with a respective sense of rotation able to cause a movement of the mixture in the axial direction from upstream to downstream namely from the mixing chamber towards the discharge chamber for discharging the mixture;
discharging the mixture, through the discharge chamber and the mixture discharge opening.

Advantageously, during the mixing step, the mixing chamber is kept connected to the external environment by means of at least one opening towards the outside so as to ensure that its internal pressure is kept at substantially atmospheric values, and mixing of the mixture is kept active only inside the mixing chamber, by performing at least one reversal by the drive unit of the sense of rotation of the rotors and therefore of the sense of advancing movement in the axial direction of the mixture from/towards the mixing chamber and towards/from the discharge chamber, in response to a signal indicating the presence or absence of the mixture inside the discharge chamber, emitted by the detection means arranged and configured to detect the presence of mixture inside the discharge chamber.

Preferably, the mixing step comprises the steps of:
starting rotation of the rotors in a respective rotation sense so as to cause a movement of the mixture in the axial direction from upstream P to downstream A namely towards the chamber for discharging the mixture;
detection, by detection means, of the presence of material inside the said discharge chamber;
emission of a corresponding signal indicating the presence of mixture;
reversal of the sense of rotation of the rotors so as to cause a movement of mixture which moves from downstream to upstream and therefore from the discharge chamber to the mixing chamber so as to cause emptying of the discharge chamber;
emission by the detection means of a signal indicating the absence of mixture inside the discharge chamber;
reversal of the sense of rotation of the rotors which are made to rotate with a positive rotation so as to cause a movement of the mixture from upstream P to downstream A and therefore from the mixing chamber towards the discharge chamber;
repetition of the steps of mixing, reversing of the feeder screws in both senses of rotation, until mixing has been completed.

Preferably, the mixture discharging step comprises the steps of:
rotating the rotors with a sense of rotation such as to cause the movement of the mixture from the mixing chamber towards the discharge chamber as far as the discharge opening;
axial discharging of the mixture through the discharge opening;
   wherein said sense of rotation is maintained independently of the detection of material inside the discharge chamber and/or emission of a corresponding signal indicating the presence of mixture inside the discharge chamber, the detection means being preferably deactivated during said discharge step.

According to a preferred embodiment, during the mixing step, control and actuating means send automatically to the drive unit a command for reversing the sense of rotation of the rotors in response to a signal, emitted by the detection means, for indicating the presence or absence of mixture inside the discharge chamber; and/or switch an operating mode of the machine from a mixing mode to a discharge mode so as to perform said discharge step, preferably after a predetermined mixing time.

The reversal of the sense of rotation of the rotors may be started after a predefined time interval Δt following the emission of the signal indicating the absence or presence of mixture inside the discharge chamber.

Further details may be obtained from the following description of a non-limiting example of embodiment of the subject of the present invention provided with reference to the attached drawings in which:

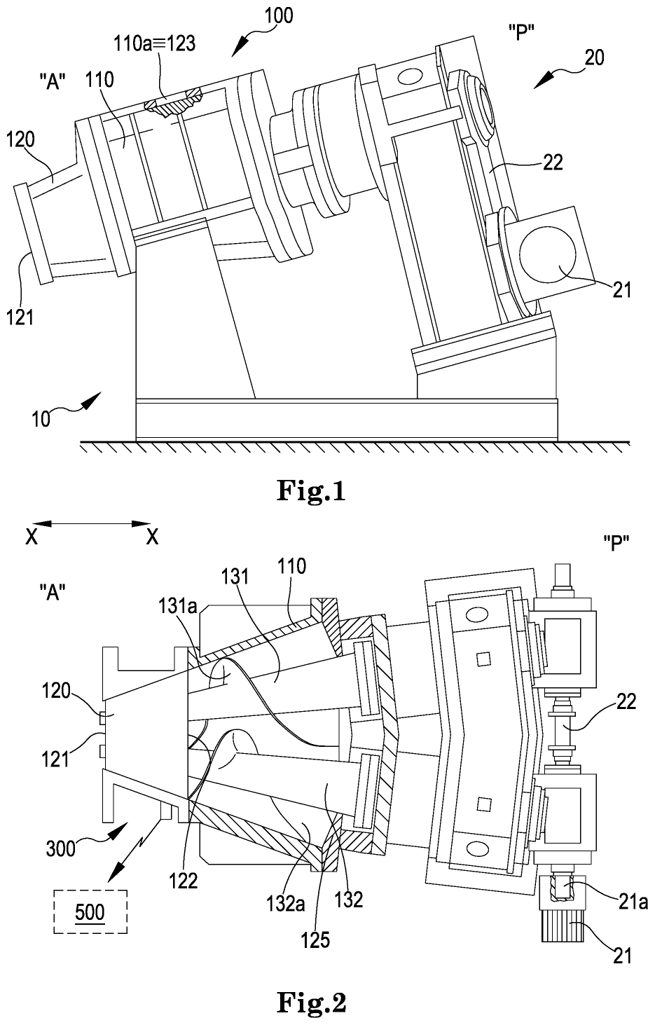

FIG. 1: shows a side view of the machine according to the present invention;

FIG. 2: shows a view from above of the machine according to FIG. 1;

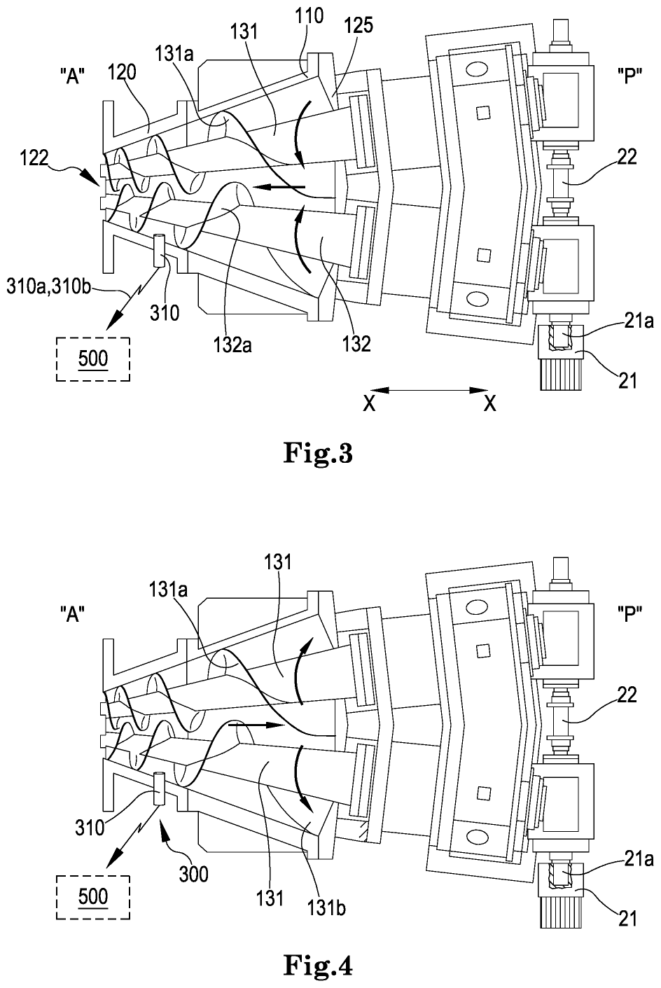

FIG. 3: shows a partially sectioned view from above of a first example of embodiment of the machine according to FIG. 1 during mixing with an axial movement of the material towards the front part;

FIG. 4: shows a partially sectioned view from above of the machine according to FIG. 3 during mixing with an axial movement of the material towards the rear part;

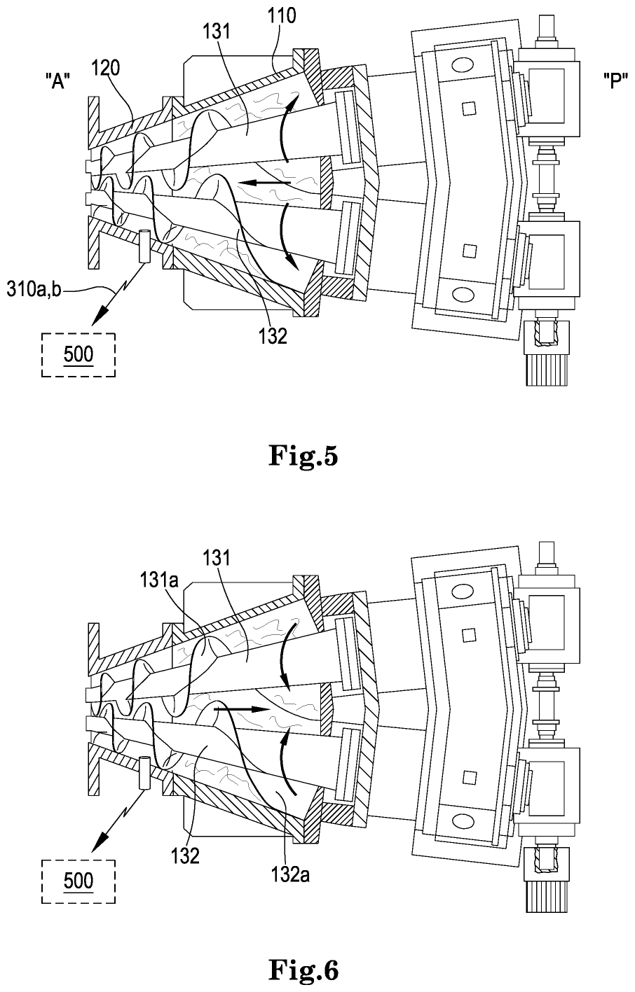

FIG. 5: shows a partially sectioned view from above of a second example of embodiment of the machine according to FIG. 1 during mixing with an axial movement of the material towards the front part;

FIG. 6: shows a partially sectioned view from above of the machine according to FIG. 5 during mixing with an axial movement of the material towards the rear part; and

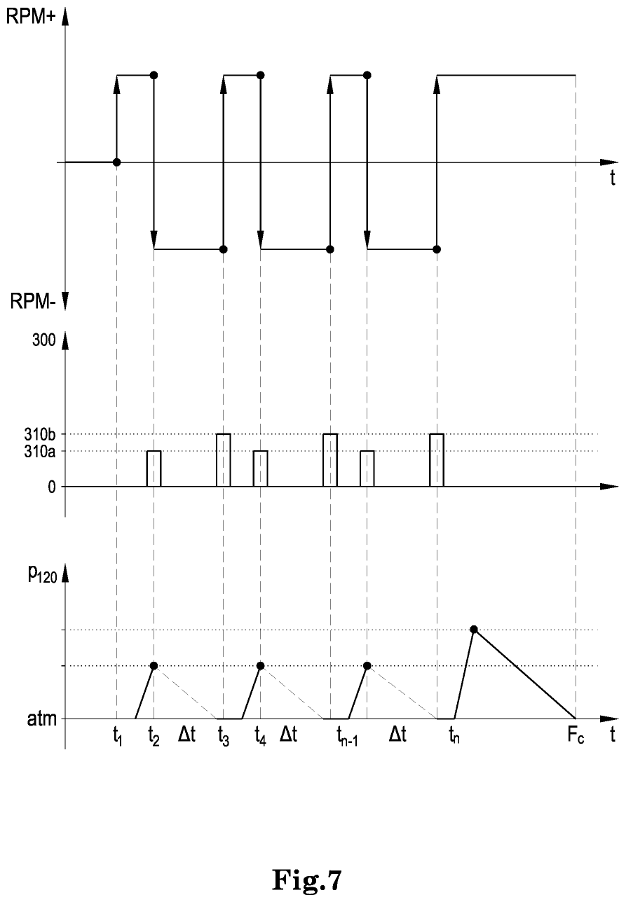

FIG. 7: shows schematic diagrams of the various operating steps of the machine according to the invention.

As shown in FIG. 1 and assuming solely for simpler description and without a limiting meaning a reference axis with a longitudinal direction X-X corresponding to the lengthwise extension of the machine; as well as a front part A or downstream part, corresponding to the part where the mixture exits and a rear part P, or upstream part, opposite to the front part, the machine according to the invention which, in its general configuration, falls within the general category of “dump extruders” comprises essentially:
a support base 10 for the functional units;
a mixing unit 100;
a drive unit 20, comprising at least one motor 21, with its shaft 21a connected to a transmission 22 designed to reverse the sense of rotation of the drive shaft 21a as will emerge more clearly below.

The mixing unit 100 comprises:
a mixing chamber 110, preferably frustoconical, arranged downstream of the drive unit 20;
a discharge chamber 120 for discharging the mixture, which is in turn preferably frustoconical, arranged downstream of the mixing chamber 110 and provided with an opening 121 for discharging the mixture in the axial direction, arranged in the front part “A” of the machine and with the upstream part mechanically connected to the mixing chamber with which it communicates in the axial direction by means of a corresponding opening 122.

Preferably (FIG. 1), the mixing chamber 110 has an opening 123 for loading the raw materials to be mixed;
a pair of inter-penetrating conical rotors 131, 132, which are respectively connected to the drive unit 20 and have their vertices at the mouth 121 of the discharge chamber 120; each rotor comprises a respective feeder screw 131a,132a mirror-inverted (with an opposite winding sense) with respect to the other one.

One 132 of the two rotors 131,132 maintains the direction of rotation of the motor 20, while the other rotor 131 receives the movement from the transmission 22, rotating in the opposite direction to the first rotor; the two rotors 131, 132 are therefore always counter-rotating.

Conventionally a positive sense of rotation RPM+ of the rotors is assumed, such as to cause an advancing movement of the mixture from upstream P to downstream A (FIGS. 3,5) and a negative sense of rotation RPM− such as to cause an advancing movement of the mixture from downstream A towards upstream P (FIGS. 4,6).

It is envisaged also that the two rotors may be each operated by an associated motor, independent of the other motor, but connected by synchronization means designed to ensure the correct rotation and prevent the feeder screws from colliding.

Advantageously, the mixing chamber 110 has at least one opening 110a in the radial direction, formed in the upwards directed part of its side surface and designed to keep the mixing chamber connected to the outside and therefore the pressure inside it at substantially atmospheric values.

It is feasible (FIG. 1) that the opening 110a and the opening 123 for loading the raw materials may coincide.

The discharge chamber has, instead, a radially closed surface and only a front opening 121 for discharging in the axial direction the mixture obtained.

Advantageously, the front discharge opening 121 may be always open towards the outside or downstream devices, a door for closing the discharge chamber 120 not being necessary nor useful since the mixing always and only takes place inside the upstream mixing chamber 110 under atmospheric pressure.

A further simplification and improvement compared to the known machines is obtained since the absence of means for closing the discharge opening helps keep the mixing at atmospheric pressure inside the mixing chamber, improving the quality of the mixture obtained, and eliminates the need for complicated automatic systems for opening and closing the discharge chamber.

According to the invention it is envisaged that means 300 for detecting the presence of mixture inside the said chamber 120 are arranged at the inlet of the discharge chamber 120, namely in the zone axially close to the mixing chamber 110; preferably said means are realized by means of a pressure sensor 310, for example connected to display means (not shown) for displaying the current value of the pressure detected.

A pressure value threshold found to be suitable for the emission of the signal indicating the presence of material inside the discharge chamber may be for example between 1 and 5 bar.

It will be clear that the person skilled in the art may select alternative and suitable detection means (for example optical means) suitable for detecting the presence of mixture inside the discharge chamber.

Preferably, the machine is provided with means 500 for controlling and actuating the moving parts of the machine, which are designed to perform the automatic operation thereof; the means 300 for detecting the presence of the mixture inside the discharge chamber in particular are connected to the control and actuating means 500. This configuration is preferred, but it will be clear to persons skilled in the art that operation of the machine described below may also be manually controlled in response to the signals emitted by the detection means.

According to the invention, the means 300 for detecting the presence of mixture inside the discharge chamber are designed, when mixture is present inside the discharge chamber 120, to emit a first logic signal 310a, for indicating the presence of material inside the discharge chamber, designed to cause the reversal of the sense of rotation of the two rotors 131,132, said reversal being able to be performed by means of the control unit 500 or manually by an operator.

The same detection means 300 are preferably designed to emit also a second logic signal 310b when the discharge chamber is emptied by the action of the rotors following the prior reversal of movement from RPM+ to RPM−.

With reference to FIGS. 3,4 which show a first embodiment of the machine according to the invention, it is possible to control the operation of the machine as follows (FIG. 7):
loading of the ingredients through a feeder mouth; preferably the rotors are at a standstill until the end-of-loading time t1;
operation of the rotors 131,132 which are made to rotate in a respective positive sense RPM+ (FIG. 3) able to cause a movement of the mixture in the axial direction from upstream “P” to downstream “A” namely towards the mixture discharge chamber 120;
entry of the (mixture) ingredients being processed into the discharge chamber 120 causes an increase in the pressure inside the chamber (t2) detected by the sensor 310;
sending to the control unit 500 by the sensor 310 of a corresponding first logic signal 310a indicating the presence of mixture;
reversal, by the control unit 500, of the sense of rotation—conventionally assumed as being negative RPM−—of the two rotors 131,132 (FIG. 4);
displacement (t3−t2) from downstream A to upstream P of the mixture caused by the reversal of the sense of rotation of the rotors;
emptying of the discharge chamber 120, caused by the reversal of the sense of rotation of the rotors, with a consequent reduction of the pressure inside the discharge chamber;
emission, by the pressure sensor 310, of a second logic signal 310b indicating the chamber 120 is empty (absence of mixture);
renewed reversal of the sense of rotation of the rotors (FIG. 3) which tend to push (t4−t3) axially the mixture again towards the discharge chamber 120;
upon entry of the mixture inside the discharge chamber 120, a new increase in pressure (t4) occurs, detected by the sensor 310 which emits a new signal 310a indicating the presence of mixture, based on which reversal of the rotation RPM− will be performed, such as to cause the return of the mixture in the axial direction towards the rear or upstream part P, with renewed emptying of the discharge chamber 120;
continuing mixing, the axial movements of the mixture from/towards the mixing chamber 110 and towards/from the discharge chamber 120 will be repeated (tn−t4), with detection by the sensor 310 of the increase/decrease of the pressure inside the discharge chamber and emission of corresponding logic signals 310a,310b indicating the presence or absence of mixture, able to perform reversals of the sense of rotation of the rotors 131,132 so as to reverse the movement of the mixture in the axial direction.

The reversals of the sense of rotation of the rotors are such as to keep the discharge chamber substantially empty of mixture and impart to the materials being processed the range of movement necessary for the incorporation and distribution/homogenization actions, needed to produce the desired mixture.

Once the mixture is obtained (tn), the sensor 300 for detecting the presence of the mixture inside the discharge chamber 120 is deactivated, interrupting the cycle for reversal of the rotations and keeping them constant, in the positive sense RPM+, such as to cause advancing in the axial direction of the mixture from the mixing chamber 110 towards the discharge chamber 120 inside which the mixture is subject to the thrust of the rotors until it exits completely in the axial direction from the mouth 121 and with the end of the cycle (Fc). It is clear that the signal emitted by the sensor may alternatively simply be ignored or disabled during the discharge step.

The switching to discharge mode is preferably performed automatically by the control unit 500, for example after a predefined mixing time, but may also be performed manually for example following an evaluation by the operator of the mixing state of the mixture.

With this operating cycle, the ingredients are kept always in the mixing state inside the mixing chamber 110 which, being open towards the outside and therefore at a substantially atmospheric pressure, does not cause undesirable increases in the temperature, avoiding damaging effects on the mixture such as alteration of the chemico-physical characteristics of the fillers and/or pre-crosslinking of the said mixture.

In the aforementioned working conditions, it has also been established in tests that an optimum degree of mixing is obtained, while ensuring the high quality of the mixture.

Preferably, one or more of the renewed reversals of the sense of rotation is started after a predefined time interval Δt following the emission of a signal by the sensor 310, in particular following a signal 310b indicating the absence of mixture. The time interval Δt≥0 may be chosen depending on the type of mixture being processed, a value Δt≥0, and in particular a value greater than time necessary for the mixture to reach the rear wall 125, being in particular recommended.

For the mixing of some types of mixture it is in fact advantageous to have prolonged pushing (Δt>>0) of the mixture against the rear wall 125, which results in a so-called “backflow” reaction, which tends to impart a component of the movement in the axial direction from upstream to downstream, opposite to the direction of movement from downstream to upstream, determined by the rotation of the feeder screws.

The movement range of the mixture thus obtained is therefore composed of three movements, i.e.:

1st movement: circumferential, generated by the rotation of the rotors;
2nd movement: main axial flow generated by the form of the feeder screws;
3rd movement: backflow, generated by the resistance of the wall 125 which, opposing the main axial flow, tends to cause the mixture being formed to flow back in the downstream direction.

The pushing of the mixture in the upstream direction and towards the rear wall in any case results in an important technical effect: any mixing material (rubber or additional ingredients, in particular in the form of pellets) left inside the rear part of the mixing chamber during rotation of the feeder screws with pushing of the mixture in the downstream direction comes into contact with the mixture and is therefore incorporated in it, therefore resulting in complete incorporation of the ingredients in the mixture and leaving the machine clean.

FIGS. 5,6, in which the same reference numbers shown in FIGS. 3,4 are used for the corresponding parts, show a second embodiment of the machine according to the invention which involves a reversal of the direction of extension of the two feeder screws 131a, 132a of the rotors 131,132; this results in operation of the machine entirely similar to that described above, but with the sense of rotation of the rotors reversed for the same preferential axial direction of movement of the mixture.

Although not shown, it is also envisaged being able to provide the machine with a cover which can be moved so as to open/close the top externally directed opening 110a,123 of the mixing chamber 110, so as to keep the opening open during mixing, in order to maintain a low pressure and low temperature, and instead closed during the discharge step, so as to produce an increase in the internal pressure and the axial thrust from upstream to downstream, in order to favour execution of the discharging action.

The present invention relates furthermore to a process for mixing rubber and/or plastic-based mixtures by means of a mixing machine, the process comprising the following steps:

a) providing a mixing machine comprising at least one mixing chamber and a discharge chamber communicating with each other in an axial direction of movement of the mixture from the mixing chamber to the discharge chamber, and
b) a pair of inter-penetrating and counter-rotating conical rollers 131,132 extending inside said chambers;
c) feeding to the machine ingredients to be mixed in order to obtain a mixture;
d) starting rotation of the rotors with a respective rotation sense RPM+ so as to cause a movement of the mixture in the axial direction from upstream P to downstream A namely towards the chamber for discharging the mixture;
e) detection by sensor means inserted inside the discharge chamber of the presence of material inside the said discharge chamber;
f) sending of a corresponding first logic signal 310a to a control unit 500;
g) reversal, by the control unit 500, of the sense of rotation RPM− of the two rotors 131,132;
h) reversal of the movement of the mixture which moves from downstream A to upstream P;
i) emptying of the discharge chamber 120;
j) emission, by the detection sensor 310, of a second different logic signal 310b indicating the absence of mixture and discharge chamber 120 empty;
k) reversal of the sense RPM+ of rotation of the rotors with renewed reversal of the movement of the mixture from upstream P to downstream A in the direction of the discharge chamber 120;
l) repetition of steps a) to k) until mixing has been completed;
m) optionally, deactivation of the sensor for detecting the presence of material inside the discharge chamber;
n) maintaining the sense RPM+ of rotation of the rotors able to cause the movement of the mixture towards the discharge chamber with a pushing force so as to favour the discharging of the mixture;
o) discharging of the mixture through the discharge mouth of the machine;
p) restoration of the initial conditions for a new cycle for mixing of a new batch of ingredients.

### Experimental Tests

The following experimental tests were carried out in a machine according to the invention with a structure and configuration as described above with reference to FIGS. 1-4. The means for detecting the presence of mixture inside the discharge chamber 120 consisted of a pressure sensor arranged inside the discharge chamber and configured to send a signal indicating the presence of mixture inside the discharge chamber when a detected pressure threshold (Threshold Pcs) is detected, and a signal indicating the absence of mixture inside the discharge chamber when the pressure values detected fall below said Threshold Pcs.

A rotation with a speed “v+” having a positive sign indicates a positive sense of rotation of the feeder screws, corresponding to an advancing direction of the mixture from upstream to downstream, while a negative speed “v-” indicates an opposite sense of rotation of the feeder screws and a direction of advancing movement of the mixture from downstream to upstream.

### Test 1

40 kg of silicone rubber and 480 g of peroxide 1.2 phr, a crosslinking agent in pellet form, were fed to the mixing chamber for mixing thereof. A temperature of the rubber entering the mixing chamber (Temp-rubber In) was measured before loading, resulting in a temperature of about 25° C. The machine was configured with the following parameters: Threshold Pcs=5 bar, Δt=180″ (seconds)

Table 1 shows the different operating steps performed by the machine at different time instants during the process.

TABLE 1

| Step | Operating state | |
|---|---|---|
| 1 | Loading of 40 kg of silicone rubber; | |
| | Loading of 480 g of peroxide | |
| | Feeder screws stationary | v = 0 RPM |
| 2 | Start of mixing with positive sense of rotation | v += 10 RPM |
| 3 | Entry of mixture into the discharge chamber | |
| | Detection | Pcs > 5 bar |
| | Reversal of sense of rotation of feeder screws | v −= 10 RPM |
| 4 | Detection | Pcs < 5 bar |
| | Emptying of discharge chamber | |
| | Maintained for Δt = 180” | v −= 10 RPM |
| 5 | Reversal of sense of rotation of feeder screws; | v += 10 RPM |
| 6 | Entry of mixture inside the discharge chamber | |
| | Detection | Pcs > 5 bar; |
| | Reversal of sense of rotation of feeder screws: | v −= 10 RPM |
| 7 | Detection | Pcs < 5 bar |
| | Emptying of discharge chamber | |
| | Maintained for Δt = 180” | v −= 10 RPM |
| 8 | Reversal of sense of rotation of feeder screws | v += 10 RPM |
| 9 | Entry of mixture inside the discharge chamber | |
| | Detection | Pcs > 5 bar |
| | Reversal of sense of rotation of feeder screws: | v −= 10 RPM |
| 10 | Detection | Pcs < 5 bar |
| | Emptying of discharge chamber | |
| | Maintained for Δt = 180 | v −= 10 RPM |
| 11 | Reversal of sense of rotation of feeder screws | v += 10 RPM |

| | |
|---|---|
| 12 | Switching to discharge mode |
| Fc | End of discharging of mixture through discharge opening. |

### Results

The temperature (Temp-mixture out) of the mixture extracted from the discharge chamber was measured at different points using a thermal probe. The temperature, Temp-mixture out, was always less than 35° C., the limit established for passing the test.

The rheometric properties was measured on 10 samples of the mixture extracted. The variation coefficient (std variation/average) for 10 samples was less than 3%.

The mixing chamber was visually inspected and it was noted that no peroxide pellets remained inside the mixing chamber.

### Test 2

50 kg of silicone rubber 100 phr were mixed with 500 g of blue pigment 1 phr.

The temperature of the rubber, Temp-rubber, was measured at 25° C. The machine was configured with the Threshold Pcs=2 bar, Δt=60″

Table 2 shows the different operating steps performed by the machine at different time instants during the process.

TABLE 2

| Step | Operating state | |
|---|---|---|
| 1 | Loading of 50 kg of silicone rubber | |
| | Loading of 500 g of blue pigment, | |
| | Feeder screws stationary, | v = 0 RPM |
| | Start of mixing with positive sense of rotation | v += 10 RPM |
| 2 | Entry of mixture inside the discharge chamber | |
| | Detection | Pcs > 2 bar; |
| | Reversal of the sense of rotation of feeder screws | v −= 10 RPM |
| 3 | Detection | Pcs < 2 bar |
| | Emptying of discharge chamber | |
| | Maintained for Δt = 60” | v −= 10 RPM |
| 4 | Reversal of sense of rotation of feeder screws | v += 10 RPM |
| 5 | Entry of mixture inside the discharge chamber | |
| | Detection | Pcs > 2 bar |
| | Reversal of sense of rotation of feeder screws | v −= 10 RPM |
| 6 | Detection | Pcs < 2 bar |
| | Emptying of discharge chamber | |
| | Maintained for Δt = 60” | v −= 10 RPM |
| 7 | Reversal of sense of rotation of feeder screws | v += 10 RPM |
| 8 | Entry of mixture inside discharge chamber | |
| | Detection | Pcs > 2 bar |
| | Reversal of sense of rotation of feeder screws | v −= 10 RPM |
| 9 | Detection | Pcs < 2 bar |
| | Emptying of discharge chamber | |
| | Maintained for Δt = 60” | v −= 10 RPM |
| 10 | Reversal of sense of rotation of feeder screws | v += 10 RPM |
| 11 | Entry of mixture inside discharge chamber | |
| | Detection | Pcs > 2 bar |
| | Reversal of sense of rotation of feeder screws | v −= 10 RPM |
| 12 | Detection | Pcs < 2 bar |
| | Emptying of discharge chamber | |
| | Maintained for Δt = 60” | v −= 10 RPM |
| 13 | Reversal of sense of rotation of feeder screws, | v += 10 RPM |
| 14 | Entry of mixture inside discharge chamber | |
| | Detection | Pcs > 2 bar |
| | Reversal of sense of rotation of feeder screws: | v −= 10 RPM |
| 15 | Detection | Pcs < 2 bar |
| | Emptying of discharge chamber | |
| | Maintained for Δt = 60” | v −= 10 RPM |
| 16 | Reversal of sense of rotation of feeder screws | v += 10 RPM |
| 17 | Entry of mixture inside discharge chamber | |
| | Detection | Pcs > 2 bar |
| | Reversal of sense of rotation of feeder screws: | v −= 10 RPM |
| 18 | Detection | Pcs < 2 bar |
| | Emptying of discharge chamber | |
| | Maintained per Δt = 60” | v −= 10 RPM |
| 19 | Reversal of sense of rotation of feeder screws | v += 10 RPM |
| 20 | Entry of mixture inside discharge chamber | |
| | Detection | Pcs > 2 bar |
| | Reversal of sense of rotation of feeder screws: | v −= 10 RPM |
| 21 | Detection | Pcs < 2 bar |
| | Emptying of discharge chamber | |
| | Maintained for Δt = 60” | v −= 10 RPM |
| 22 | Reversal of sense of rotation of feeder screws | v += 10 RPM |
| 23 | Entry of mixture inside discharge chamber | |
| | Detection | Pcs > 2 bar |
| | Reversal of sense of rotation of feeder screws | v −= 10 RPM |
| 24 | Detection | Pcs < 2 bar |
| | Emptying of discharge chamber | |
| | Maintained for Δt = 60” | v −= 10 RPM |
| 25 | Reversal of sense of rotation of feeder screws | v += 10 RPM |

| | |
|---|---|
| 26 | Switching to discharge mode |
| Fc | Completion of discharging of mixture through discharge opening |

### Results

The temperature (Temp-mixture out) of the mixture extracted from the discharge chamber was measured at different points using a thermal probe.

The temperature, Temp-mixture out, was always less than 35° C., the limit established for passing the test.

The homogeneity of the colour of the mixture was assessed visually. The colour was uniformly distributed without coloured zones.

It is therefore clear how with the machine and the process according to the invention it is possible to perform processing of the mixture at a low pressure, substantially ambient pressure, and at very low temperatures and/or without an undesirable increase in the temperature of the mixture, while improving the quality of the mixture obtained; in addition the possibility of controlling and determining the direction of the flow of material is able to ensure a movement range suitable for obtaining satisfactory mixing and/or complete mixing of all the ingredients.

Although described in connection with a number of embodiments and a number of preferred examples of implementation of the invention, it is understood that the scope of protection of the present patent is determined solely by the claims below.

1.-17. (canceled)

18. A machine for mixing elastomeric materials, comprising
a drive unit (20)
a mixing unit for mixing a mixture, comprising a mixing chamber (110) arranged downstream of the drive unit (20); and a discharge chamber (120) arranged downstream of the mixing chamber (110) with which it communicates towards upstream, and provided with a discharge opening (121) for discharging the mixture;
a pair of inter-penetrating and counter-rotating conical rotors (131,132), each rotor comprising a respective feeder screw (131a,132a) mirror-inverted with respect to the feeder screw of the other rotor, wherein the rotors are respectively connected upstream with the drive unit (20) so that the drive unit rotationally drives the rotors and have their vertices situated at the discharge opening (121) of the discharge chamber (120);
a detection means (300) arranged and configured to detect the presence of the mixture inside the discharge chamber (120) and to emit at least one signal for indicating the presence (310a) or absence (310b) of mixture inside the discharge chamber (120);
wherein the mixing chamber (110) has at least one opening (110a) towards the outside adapted to keep it connected with the external environment so as to ensure that its internal pressure remains at substantially atmospheric values, and
and wherein, based on the signal indicating the presence or absence of mixture, the machine is configured to cause, during a mixing step, at least one reversal by the drive unit (20) of a sense of rotation of the rotors (131,132) and therefore of a sense of advancing movement in the axial direction of the mixture from/towards the mixing chamber and towards/from the discharge chamber, so as to keep mixing of the mixture active only inside the mixing chamber (110).

19. The machine according to claim 18, wherein the detection means (300) are arranged inside the discharge chamber (120) in the vicinity of the zone for connection to the mixing chamber.

20. The machine according to claim 18, wherein the mixing chamber (110) and the discharge chamber (120) are frustoconical and axially connected together.

21. The machine according to claim 18, comprising a loading opening (123) for loading ingredients to be mixed to obtain said mixture.

22. The machine according to claim 21, wherein said loading opening (123) is one of the said at least one opening (110a) for connecting the mixing chamber to the external environment.

23. The machine according to any claim 18, wherein said drive unit (20) comprises at least one motor (21) with drive shaft (21a) for rotationally driving one (131;132) of the two rotors and a transmission (22) designed to reverse the direction of rotation of the drive shaft (21a) and connected to the other one (132;131) of the two rotors.

24. The machine according to claim 18, further comprising a control means (500) for controlling and actuating the moving parts of the machine, designed to perform automatic operation thereof.

25. The machine according to the claim 24, wherein said control means (500) are configured to send automatically to the drive unit (20) a command for reversing the sense of rotation of the rotors (131,132) in response to a signal indicating the presence (310a) or absence (310b) of mixture inside the discharge chamber, emitted by the detection means (300) during the mixing step.

26. The machine according to claim 24, wherein said control means (500) are configured to switch an operating mode of the machine from a mixing mode to a discharging mode whereby a sense (RPM+) of rotation of the rotors is maintained so as to cause the movement of the mixture from the mixing chamber towards the discharge chamber (120) and the axial discharging thereof through the discharge mouth (122).

27. The machine according to claim 18, characterized in that it comprises a cover which can be moved between an open and a closed position so as to close the mixing chamber (110) during axial discharging of the mixture, the cover being arranged to close one of said at least one opening for communicating with the external environment and/or a loading opening.

28. The machine according to claim 18, wherein the discharge opening for discharging the mixture is always open towards the external environment, no means being provided for closing thereof.

29. A process for mixing elastomeric materials by means of a mixing machine according to claim 18, which comprises the steps of:
feeding to the mixing chamber ingredients to be mixed to obtain a mixture;
mixing of the ingredients by the feeder screws (131a,132a) of the rotors (131;132) which are made to rotate with a respective sense (RPM+) of rotation such as to cause a movement of the mixture in the axial direction from upstream (P) to downstream (A) namely from the mixing chamber towards the discharge chamber (120) for discharging the mixture;
discharging the mixture through the discharge chamber (120) and the discharge opening;
wherein, during the mixing step, the mixing chamber (110) is kept connected to the external environment by means of at least one opening (110a) towards the outside so as to ensure that its internal pressure is kept at substantially atmospheric values;
and wherein, during the mixing step, mixing of the mixture is kept active only inside the mixing chamber (110) by performing at least one reversal by the drive unit (20) of the sense of rotation of the rotors (131,132) and therefore of the sense of advancing movement in the axial direction of the mixture from/towards the mixing chamber and towards/from the discharge chamber, in response to a signal for indicating the presence (310a) or absence (310b) of the mixture inside the discharge chamber (120), emitted by the detection means (300) arranged and configured to detect the presence of mixture inside the discharge chamber (120).

30. The process according to claim 29, wherein the mixing step comprises the steps of:
a. starting the rotation of the rotors in a respective rotation sense (RPM+) so as to cause movement of the mixture in the axial direction from upstream (P) to downstream (A) namely towards the chamber (120) for discharging the mixture;
b. detection, by detection means (300), of the presence of mixture inside the discharge chamber (120);
c. emission of a corresponding signal (310a) indicating the presence of mixture;
d. reversal of the sense (RPM+) of rotation of the rotors so as to cause a movement of the mixture in the axial direction from downstream (A) to upstream (P) and therefore from the discharge chamber (120) to the mixing chamber, so as to cause emptying of the discharge chamber (120);
e. emission by the detection means (300) of a signal (310b) indicating the absence of mixture inside the discharge chamber (120);
f. reversal of the sense (RPM−) of rotation of the rotors which are made to rotate with a rotation sense (RPM+) designed to cause a movement of the mixture from upstream (P) to downstream (A) in the axial direction and therefore from the mixing chamber to the discharge chamber (120);
g. repetition of steps b) to h) until mixing has been completed.

31. The process according to claim 29, wherein the mixture discharging step comprises the steps of:
starting rotation of the rotors with a sense (RPM+) of rotation able to cause the movement of the mixture from the mixing chamber towards the discharge chamber (120) as far as the discharge opening;
axial discharging of the mixture through the discharge opening (122);
wherein said sense of rotation is maintained independently of the detection of mixture inside the discharge chamber and/or the emission of a corresponding signal (310a) indicating the presence of mixture inside the discharge chamber, the detection means (300) being preferably deactivated during said discharge step.

32. The process according to claim 29, wherein during the mixing step control means (500) send automatically to the drive unit (20) a command for reversing the sense of rotation of the rotors (131,132), in response to a signal for indicating the presence (310a) or absence (310b) of mixture inside the discharge chamber, emitted by the detection means (300); and/or wherein
control and means (500) switch an operating mode of the machine from a mixing mode to a discharge mode so as to perform said discharge step, preferably after a predefined mixing time.

33. The process according to claim 29, wherein the reversal of the sense of rotation (RPM+) of the rotors (131,132), following a signal indicating the absence (310b) or presence of mixture inside the discharge chamber, emitted by the detection means (310), is started immediately after or after a predefined time interval (Δt) following the emission of the signal.

34. The process according to claim 29, wherein loading of the ingredients is performed via a top loading opening (100) and/or in that an opening towards the outside and in particular the loading opening is closed during the discharging step.

35. The machine according to claim 25, wherein said reversal command is sent immediately after and/or after a predefined time interval (Δt) following the emission of a signal indicating the presence (310a) or absence of mixture inside the discharge chamber (120).

36. The machine according to claim 35, wherein the reversal command is sent immediately after the emission of a signal indicating the presence (310a) of mixture inside the discharge chamber (120) and after a predefined time interval (Δt) following the emission of a signal indicating the absence of mixture inside the discharge chamber (120).
